(19) United States
(12) Patent Application Publication
(10) Pub. No.: US 2014/0046708 A1
(43) Pub. Date: Feb. 13, 2014

(54) SYSTEMS AND METHODS FOR DETERMINING A CLOUD-BASED CUSTOMER LIFETIME VALUE

(71) Applicant: Benjamin Werner, Bellevue, WA (US)

(72) Inventor: Benjamin Werner, Bellevue, WA (US)

(73) Assignee: Oracle International Corporation, Redwood Shores, CA (US)

(21) Appl. No.: 13/568,935

(22) Filed: Aug. 7, 2012

(51) Int. Cl. G06Q 30/02

(52) U.S. Cl. 705/7.11

(57) ABSTRACT

Various arrangements for determining a customer lifetime value metric are presented. A first customer record stored by the cloud host computer system on behalf of a first client may be accessed. The first customer record may include information about a first financial relationship between a customer and the first client. A second customer record stored by the cloud host computer system on behalf of a second client may be accessed. The second customer record may include information about a second financial relationship between the customer and the second client. The clients may not have access to each other's customer records. The customer indicated in the first customer record and the customer indicated in the second customer record may be determined to be the same. The customer lifetime value metric may be determined using information from the first financial relationship and the second financial relationship.

### BACKGROUND

Cloud-based hosting services are becoming prevalent. Typically, in a cloud-based hosting arrangement, a cloud-based service provider provides storage and/or processing capabilities for a number of clients over a network, such as the Internet. Each of these clients, such as different business organizations, may be unrelated, and each client does not have access to each other client's data stored and/or processed by the cloud-based service provider.

### SUMMARY

Various arrangements for determining a customer's value is provided. In some embodiments, a method for determining a customer's value is presented. The method may include accessing, by a cloud host computer system, a first customer record stored by the cloud host computer system on behalf of a first client. The first customer record may comprise information about a first financial relationship between a customer and the first client. The method may include accessing, by the cloud host computer system, a second customer record stored by the cloud host computer system on behalf of a second client. The second customer record may comprise information about a second financial relationship between the customer and the second client. The first client may not have access to the second customer record. The second client may not have access to the first customer record. The method may include determining, by the cloud host computer system, the customer of the first customer record and the customer of the second customer record are the same. The method may include determining, by the cloud host computer system, a community customer lifetime value metric using information about the first financial relationship and information about the second financial relationship. The method may include providing, by the cloud host computer system, the community customer lifetime value metric to the first client.

Embodiments of such a method may include one or more of the following: The customer lifetime value metric may be the only metric provided to the first client by the cloud host computer system based on the second customer record. The information about the first financial relationship between the customer and the first client may comprise information about revenue received by the first client from the customer. The information about the second financial relationship between the customer and the second client may comprise information about revenue received by the second client from the customer. The information about the first financial relationship between the customer and the first client may comprise information about customer-support costs of the customer with the first client. The information about the second financial relationship between the customer and the second client may comprise information about customer-support costs of the customer with the second client. The customer may be a person. The customer may be a business organization. The method may include accessing, by the cloud host computer system, a social influence score for the customer. The social influence score may indicate a likelihood of the customer being able to influence behavior of people. The method may include determining, by the cloud host computer system, the community customer lifetime value metric using the first financial relationship and the second financial relationship may further comprise using the social influence score for the customer. The method may include accessing, by the cloud host computer system, a plurality of customer records stored by the cloud host computer system on behalf of a plurality of clients. The plurality of customer records may correspond to the customer.

Further, embodiments of such a method may include one or more of the following: The plurality of customer records may comprise information about a plurality of financial relationships between the customer and the plurality of clients. The method may include determining, by the cloud host computer system, the community customer lifetime value metric using the first financial relationship and the second financial relationship further comprises using the information about the plurality of financial relationships between the customer and the plurality of clients. Providing, by the cloud host computer system, the community customer lifetime value metric to the first client further may comprise providing the community customer lifetime value metric to each client of the plurality of clients. The method may include receiving, by the cloud host computer system, an indication that the first client is enrolled in a community customer lifetime value program. The community customer lifetime value program may permit access community to customer lifetime value metrics for a plurality of customers determined using at least some data not available to the first client. The community customer lifetime value program may require customer records, that are stored on behalf of the first client by the cloud host computer system, be available for use in determining the community customer lifetime value metrics for the plurality of customers.

In some embodiments, a computer program product residing on a non-transitory processor-readable medium for determining a customer's value may be presented. The computer program product may comprise processor-readable instructions configured to cause a processor to access a first customer record stored by the cloud host computer system on behalf of a first client. The first customer record may comprise information about a first financial relationship between a customer and the first client. The computer program product may comprise processor-readable instructions configured to cause the processor to access a second customer record stored by the cloud host computer system on behalf of a second client. The second customer record may comprise information about a second financial relationship between the customer and the second client. The first client may not have access to the second customer record. The second client may not have access to the first customer record. The computer program product may comprise processor-readable instructions configured to cause the processor to determine the customer of the first customer record and the customer of the second customer record are the same. The computer program product may comprise processor-readable instructions configured to cause the processor to determine a community customer lifetime value metric using information about the first financial relationship and information about the second financial relationship. The computer program product may comprise processor-readable instructions configured to cause the processor to provide the community customer lifetime value metric to the first client.

Embodiments of such a computer program product may include one or more of the following: The customer lifetime value metric may be the only metric provided to the first client based on the second customer record. The information about the first financial relationship between the customer and the first client may comprise information about revenue received by the first client from the customer. The information about the second financial relationship between the customer and the second client may comprise information about revenue received by the second client from the customer. The information about the first financial relationship between the customer and the first client may comprise information about customer-support costs of the customer with the first client. The information about the second financial relationship between the customer and the second client may comprise information about customer-support costs of the customer with the second client. The customer may be a person or a business organization.

Further, embodiments of such a computer program product may include one or more of the following: The computer program product may comprise processor-readable instructions configured to cause the processor to access a social influence score for the customer. The social influence score may indicate a likelihood of the customer being able to influence behavior of people. The computer program product may comprise processor-readable instructions configured to cause the processor to determine the community customer lifetime value metric using the first financial relationship and the second financial relationship further comprises using the social influence score for the customer. The computer program product may comprise processor-readable instructions configured to cause the processor to receive an indication that the first client is enrolled in a community customer lifetime value program. The community customer lifetime value program may permit access community to customer lifetime value metrics for a plurality of customers determined using at least some data not available to the first client. The community customer lifetime value program may require customer records, that are stored on behalf of the first client by the cloud host computer system, be available for use in determining the community customer lifetime value metrics for the plurality of customers.

In some embodiments, a system for determining a customer's value may be presented. The system may include a processor. The system may include a memory communicatively coupled with and readable by the processor and having stored therein processor-readable instructions. The processor readable instructions, when executed by the processor, may cause the processor to access a first customer record stored by the cloud host computer system on behalf of a first client. The first customer record may comprise information about a first financial relationship between a customer and the first client. The processor readable instructions, when executed by the processor, may cause the processor to access a second customer record stored by the cloud host computer system on behalf of a second client. The second customer record may comprise information about a second financial relationship between the customer and the second client. The first client may not have access to the second customer record. The second client may not have access to the first customer record. The processor readable instructions, when executed by the processor, may cause the processor to determine the customer of the first customer record and the customer of the second customer record are the same. The processor readable instructions, when executed by the processor, may cause the processor to determine a community customer lifetime value metric using information about the first financial relationship and information about the second financial relationship. The processor readable instructions, when executed by the processor, may cause the processor to provide the community customer lifetime value metric to the first client. Embodiments of such a system may involve the customer lifetime value metric being the only metric provided to the first client based on the second customer record.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a system for determining a customer lifetime value metric.

FIG. 2 illustrates another embodiment of a system for determining a customer lifetime value metric.

FIG. 3 illustrates an embodiment of a method for determining a customer lifetime value metric.

FIG. 4 illustrates another embodiment of a method for determining a customer lifetime value metric.

FIG. 5 illustrates an embodiment of a contact entry which may be used for determining a customer lifetime value metric.

FIG. 6 illustrates an embodiment of a computer system.

### DETAILED DESCRIPTION

In a cloud-based hosting arrangement, a cloud-based service provider provides storage and/or processing capabilities for a number of clients over the Internet. Each of these clients such as different business organizations, may be unrelated, and each client may not have access to each other client's data stored by the cloud-based service provider. However, since the cloud-based service provider is serving as a common host for each of the clients, the cloud-based service provider may have access to each client's data.

Such data may include information on customers of the clients, such as customer records. For example, a client may maintain a database stored by the cloud-based service provider that contains customer records about customers' relationships with the client. Such information may include: contact information, a purchase history, a purchase return history, a customer support history, etc. Such data may be valuable to the client because the data may be used to determine the value of the customer to the client. For example, a customer that has a significant purchase history with the client may be provided with deeper discounts or better customer service than another customer that has a smaller purchase history with the client.

While looking at a purchase history may be a relatively straightforward way for the client to determine which of its customers are the most valuable, using such a metric may not provide the client with a fully accurate representation of the customer's worth to the client. For instance, while a customer may have made a significant amount of purchases from the client, an above-average amount of returns and/or significant use of customer support by the customer may erode or even eliminate the profit margin of the client with the customer. As such, these factors may be desired to be taken into account when determining the value of a customer to the client.

Customer lifetime value (CLV) may be a prediction of the net profit that can be attributed to a relationship with a customer in the future. Determining the CLV for a customer may be based on the customer's past purchases with the client, purchase return history with the client, and customer support history with the client to name only a few factors. Such a CLV metric may be limited in value because it is restricted to transactions conducted with only the client.

A more useful metric may be a CLV for a customer calculated across multiple business clients for several reasons. As a first example, while a customer may have previously made only small purchases with a first client, this same customer may have made much larger purchases with a second client. If the first client was aware of these purchases with the second client, the first client may alter its business arrangement with the customer, such as through better customer service, white-glove treatment, extra perks, giveaways, or discounts in the hope of persuading the customer to conduct additional business with the first client. As a second example, while a customer has had a relationship with a first client that has been profitable for the first client, the customer may have had a relationship with a second client that has not been profitable for the second client, such as due to an above-average number of product returns and/or a large amount of use of customer service by the customer (many other factors may also cause the profitability due to the customer to drop). As such, the first client may desire to devalue its relationship with the customer based on this second client's history with the customer.

Typically, relationship information between a customer and a client is not available to other entities, such as other clients. However, if the data related to the relationship between the customer and the client is stored by a cloud-based service provider, the cloud-based service provider may be permitted to access such information. The cloud-based service provider may gather relationship information between a particular customer and multiple clients who store data with the cloud-based service provider.

Based on the relationship information between a particular customer and multiple clients who store data with the cloud-based service provider, the cloud-based service provider may be able to produce a CLV metric that takes into account relationship information across multiple clients that the customer has had transactions with. This may allow for the creation of a more accurate CLV metric because it takes into account transactions between the customer and multiple clients, rather than only a particular client.

The CLV determined by the cloud-based service provider may be provided (e.g., sent to or made available to) each client of the CLV, or at least each client associated with relationship information that was used to determine the CLV of the customer. Therefore, an exchange of data may exist between the cloud-based service provider and a client: in exchange for permitting the cloud-based service provider to access customer records containing the relationship information between customers and the client, the client receives a CLV metric, which may be based on customer records containing relationship information gathered from multiple clients of the cloud-based service provider.

The CLV metric may be purposefully configured to be simple. The CLV metric may be a single number. This single number may vary over a range from 0-100. As such, by looking at a single number, a person can evaluate the CLV of a customer across multiple clients. This amount of data can be referred to as “big data,” meaning it may be difficult for a person to interpret without processing assistance. Further, by having the CLV metric be a single number, the risk of a first client being able to discern specific information about a relationship between a customer and a second client is significantly limited. As such, while the CLV relies on relationship information gathered from the customer records of multiple clients, the CLV may be shared with multiple clients by the cloud-based service provider without significantly impacting proprietary information held about customers by the clients.

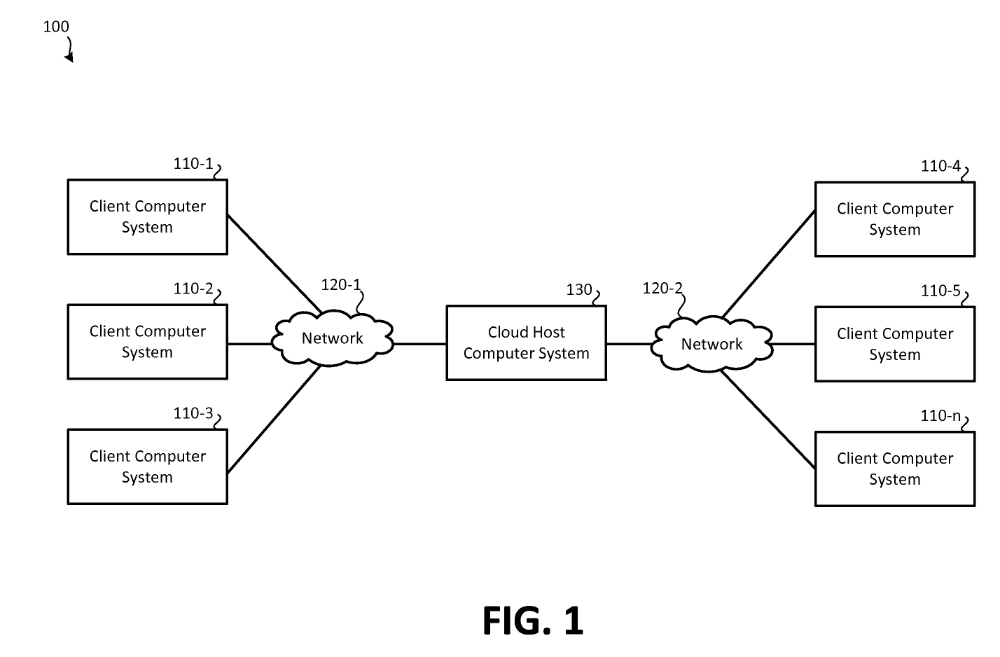

FIG. 1 illustrates an embodiment of a system 100 for determining a customer lifetime value (CLV) metric. System 100 may be used for determining a CLV metric based on information stored by a cloud-based service provider on behalf of multiple clients. Such a CLV metric may be referred to as a community CLV metric because it is based on information gathered from the records of multiple clients. These clients may not otherwise share information. System 100 may include: client computer systems 110, network 120, and cloud host computer system 130.

Each client computer system of client computer systems 110 may represent a computer system operated by or on behalf of a client. A client may be a person or organization (e.g., a business organization, such as a company) that has data stored and/or processed by a cloud-based service provider (via cloud host computer system 130). Data that is to be stored and/or processed by cloud host computer system 130 on behalf of a client may be transferred from a computer system of the client, such as client computer system 110-1 to cloud host computer system 130 via network 120-1. Data transferred to cloud host computer system 130 by client computer system 110-1 may include information about a customer of the client on whose behalf client computer system 110-1 is operated. The information about the customer may be in the form of a customer record. A customer may be a person or organization (e.g., a business entity, such as a company) that purchases goods and/or services from a client. A customer may also sell goods and/or services to the client.

Information about a customer that may be transferred by a client to cloud host computer system 130 (such as for storage) may include: contact information (e.g., a business phone number, a cellular phone number, an address, a mailing address, an email address, a webpage of the customer, etc.), a purchase/sales history (e.g., information on quantities, dates, and types of goods and/or services bought or sold to or from the client), a customer service history (e.g., the dates, times, and lengths, of interactions with the client's customer service providers), and/or a return history (e.g., indications of products and/or costs of products that have been returned, either for a refund, exchange, or via a warranty). It should be understood that such information about a customer is provided as an example; different clients may store different types of information about their respective customers. Such information may be stored by the cloud-based service provider as a customer record.

Each client computer system of client computer systems 110 may include one or more computers. Further, each client computer system of client computer systems 110 may be unrelated to each other client computer system of client computer systems 110. As such, client computer systems 110 may not share data, including customer records, with each other. While each of client computer systems 110 may have data stored and/or processed by a cloud host computer system, clients may not have access to each other's data on the cloud host computer system. As an example, client computer system 110-1 may be operated on behalf of Company A while client computer system 110-2 may be operated on behalf of Company B. Customer records for Company A may be uploaded from client computer system 110-1 to cloud host computer system 130 for storage. Customer records (possibly in a different format) for Company B may be uploaded from client computer system 110-2 to cloud host computer system 130 for storage. Company A may not be permitted to access the customer records of Company B and Company B may not be permitted to access the customer records of Company A. As such, while both companies rely on the same cloud-based service provider, each company's customer information is maintained as private by the cloud host computer system for the corresponding company.

While system 100 illustrates six client computer systems 110 in communication with cloud host computer system 130, it should be understood that fewer or greater numbers of client computer systems 110 may be in communication with cloud host computer system 130. For example, cloud host computer system 130 may provide cloud-based processing and/or storage services for thousands of different clients.

Networks 120 may be used for communication between cloud host computer system 130 and client computer systems 110. Networks 120 may include one or more private and/or public networks. A private network may be a corporate intranet; a public network may be the Internet. Network 120-1 may represent the same or a different network from network 120-2.

Cloud host computer system 130 may be operated on behalf of a cloud-based service provider. Cloud host computer system 130 may include one or more computers, which may be scattered geographically. Cloud host computer system 130 may be used to provide data processing and/or data storage services to multiple clients. Data stored and/or processed by cloud host computer system 130 may be maintained separately for each client, such that clients do not have access to each other's data (unless such permission is provided).

Data stored by cloud host computer system 130 may include data on customers of clients, such as in the form of customer records. Since each client's data is maintained separate, some clients may have information about the same clients. For example, customer 1 may have made a purchase from company A, associated with client computer system 110-1, and also may have made a purchase from company B, associated with client computer system 110-2. While cloud host computer system 130 may store data about each of these purchases by the customer, the data for each of the purchase may be maintained separately (and may be maintained in different formats) due to each client's data being maintained separate by cloud host computer system 130. A client may have a customer that has not had any transactions with one or more other clients of the cloud-based service provider. Relationship information about this customer, while stored by the cloud host computer system, may only be available to the client that has transacted with the customer and provided the data on the customer to the cloud host computer system.

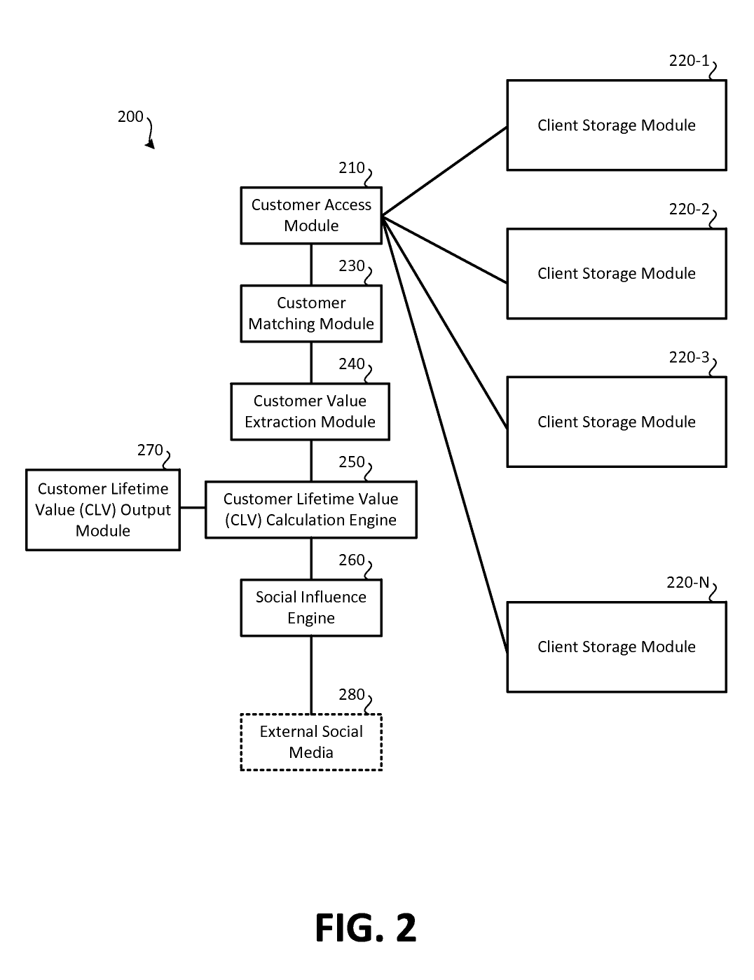

FIG. 2 illustrates another embodiment of a system 200 for determining a customer lifetime value metric. System 200 represents various components that may be implemented as hardware, firmware, and/or software, which are executed using hardware. The components of system 200 of FIG. 2 may be implemented by cloud host computer system 130. As such, system 200 may be implemented as part of system 100 of FIG. 1 or using some other hardware arrangement. System 200 may include: customer access module 210, client storage modules 220, customer matching module 230, customer value extraction module 240, CLV calculation engine 250, social influence engine 260, and CLV output module 270.

Customer access module 210 may be implemented by the cloud-based service provider to access data stored by multiple clients that use the cloud host computer system of the cloud-based service provider for processing and/or storage services. In order to use the data stored by the multiple clients, the cloud-based service provider may first have requested permission from each client to use their data in calculating a CLV metric. The data of clients that have not provided permission may not be used. Clients that have not provided permission may not be provided access to the calculated CLV metric. Therefore, only clients that provide access to their data may be provided with the calculated CLV metric.

Customer access module 210 may examine data, such as customer records, stored in each client storage module of client storage modules 220 that is associated with a client that has provided access permission. Each client storage module of client storage modules 220 represents data stored by the cloud host computer system on behalf of clients (or otherwise available to the cloud host computer system). Each client storage module is associated with a different client and only the associated client (and the cloud-based service provider, if permission was given) is permitted to access the data in a client storage module. In system 200, access permission was provided for access to each client storage module of client storage modules 220 for use in creating a CLV metric. While client storage modules are illustrated as distinct, some or all of client storage modules 220 may be implemented on the same computer-readable storage medium hardware. Client storage modules 220 may only be distinct so far as each module is associated with a particular client and a client is not permitted to access data associated with other clients in other client storage modules. While four client storage modules 220 are illustrated, it should be understood that greater or fewer client storage modules 220 may be present in various embodiments.

Customer access module 210 may examine data, such as customer records, within each client storage module of client storage modules 220 for data specific to customers. Customer access module 210 may retrieve information and identification information from each client storage module of client storage modules 220, such as: contact information (e.g., a business phone number, a cellular phone number, an address, a Social Security number, a mailing address, an email address, a webpage of the customer, etc.), a purchase/sales history (e.g., information on quantities, dates, and types of goods and/or services bought or sold to or from the client), a customer service history (e.g., the dates, times, and lengths, of interactions with the client's customer service providers), and/or a return history (e.g., indications of products and/or costs of products that have been returned, either for a refund, exchange, or via a warranty).

Since multiple clients may have at least some of the same customers, data indicative of the same customer retrieved from multiple clients should be linked together. Customer matching module 230 may receive customer data from customer access module 210. Contact information for customers may be used to identify which customer records are associated with the same customer. For example, if contact information from a customer's record retrieved from client storage module 220-1 indicates the customer's phone number is “222-555-2727” and contact information retrieved from another customer record of client storage module 220-2 indicates the same phone number, it may be determined by customer matching module 230 that both of these records correspond to the same customer. Various pieces of contact information may be used alone or in combination with other contact information to determine if two records correspond to the same customer, such as: address, name, email address, phone number, social security number, date of birth, organization name (e.g., company name), credit card/debit card/stored value card number, account identifier, loyalty program identifier, etc. Using such data, customer matching module 230 may aggregate data for individual customers that have records in more than one client storage module of client storage modules 220.

Customer value extraction module 240 may use the aggregated data for customers created by customer matching module 230 to extract data for each customer pertinent to calculation of a customer lifetime value metric. The CLV metric may take into account some or all transactions and/or interactions by the customer with one or more clients in the past as indicated by the data stored in client storage modules 220. Customer value extraction module 240 may output data sufficient to calculate a CLV metric to CLV calculation engine. CLV calculation engine 250 may receive the data from customer value extraction module 240 and may calculate a CLV metric. This CLV metric may be referred to as a community CLV metric because it relies on data from multiple clients whose data is not ordinarily pooled. The output of CLV calculation engine 250 may be a single metric, such as a single number. For example, the number may be on a scale of 0 to 100 to allow for easy interpretation by clients. CLV calculation engine 250 may use data for the customer, retrieved from one or more client storage modules of client storage modules 220, regarding a purchase/sales history (e.g., information on quantities, dates, and types of goods and/or services bought or sold to or from the client) for the customer, a customer service history (e.g., the dates, times, and lengths, of interactions with clients' customer service providers) for the customer, and/or a return history (e.g., indications of products and/or costs of products that have been returned, either for a refund, exchange, or via a warranty) for the customer.

In addition to using data about a customer extracted from client storage modules 220, CLV calculation engine 250 may use information from one or more external sources in determining the CLV metric. CLV calculation engine 250 may receive information from social influence engine 260. A social influence engine, which may be operated by the cloud-based service provider or by a third-party service provider, may assess how likely a customer is to influence others (e.g., persons or business entities). For instance, while a customer may have only made a handful of purchases with any of the clients associated with client storage modules 220, the customer may have a large amount of influence over other current and/or potential customers. As an example of this, celebrities have TWITTER feeds, FACEBOOK pages, or GOOGLE PLUS accounts that are followed by millions of people. A bad experience with a client by a celebrity may lead to a negative social media post by the celebrity, causing harm to the client's reputation. As such, even with a small purchase history, it may be desirable to give a celebrity customer a higher CLV metric due to the celebrity's disproportionate social influence on other current and/or potential customers.

Social influence engine 260 may analyze the customer's presence in news media and/or social media to determine an amount of social influence. For instance, social influence engine 260 may access one or more sources of external social media 280 to determine an amount of social influence that a customer has on others. This may be assessed by determining a number of “followers,” “contacts,” and/or “friends” that the customer has. This information may be the only or some of the only information publically available about the customer. Such information may be provided to CLV calculation engine 250 for use in calculating the CLV metric. Despite social influence data on the customer being provided to CLV calculation engine 250, only a single metric for each customer may be output by CLV calculation engine 250.

CLV output module 270 may receive the CLV metrics for multiple clients. These CLV metrics may be provided to each client that has a current relationship with the customer (e.g., each client that stores data about the customer), or may be provided to all clients (that provided access to their client storage modules) of the cloud-based service provider. This may involve the CLV output module 270 storing a customer's CLV metric in a record in each client storage module of client storage modules 220, transmitting the CLV metric to each client (such as to client computer systems 110) or making the CLV metric available for access by the clients. Periodically, such as once per day, week, month, or year, the CLV metric may be updated for some or all customers. In some embodiments, the CLV metric may be updated in real time, such that as additional data about the customer is stored and/or processed by the cloud-based service provider, the CLV metric is updated.

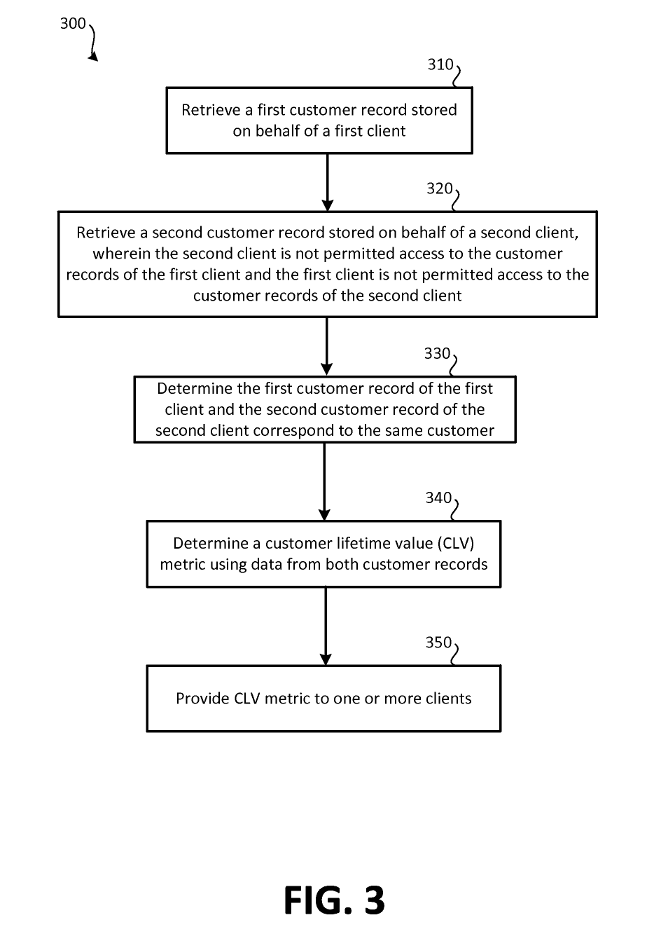

FIG. 3 illustrates an embodiment of a method 300 for determining a customer lifetime value metric. Method 300 may be performed by a computer system including one or more computers. For example, method 300 may be performed by cloud host computer system 130 of FIG. 1. Similarly, method 300 may be performed using system 200 of FIG. 2, which may represent some or all components of cloud host computer system 130. Accordingly, means for performing method 300 includes one or more computers (including servers), computer-readable storage devices, one or more networks, and one or more client computer systems.

At step 310, a first customer record may be retrieved from storage. The first customer record may be stored by the cloud-based service provider using a cloud host computer system. The customer record may include: contact information (e.g., a business phone number, a cellular phone number, an address, a mailing address, an email address, a webpage of the customer, etc.), a purchase/sales history (e.g., information on quantities, dates, and types of goods and/or services bought or sold to or from the client), a customer service history (e.g., the dates, times, and lengths, of interactions with the client's customer service provider), and/or a return history (e.g., indications of products and/or costs of products that have been returned, either for a refund, exchange, or via a warranty). It should be understood that such information about a customer is provided as an example; different clients may store different types of information about their respective customers.

At step 320, a second customer record may be retrieved from storage. The second customer record may be stored by the cloud-based service provider using the same cloud host computer system. The second customer record may contain at least some information similar to the first customer record. While the cloud-based service provider may store the first and second customer record, these records may be maintained separately such that the first client does not have access to the second client's customer records. Likewise, the second client may not have access to the first client's customer records. More generally, the first client may only have access to data provided to the cloud host computer system by the first client and the second client may only have access to data provided to the cloud host computer system by the second client. Assuming permission was granted, the cloud-based service provider may be permitted to retrieve the customer records stored on behalf of each client for the purpose of calculating a CLV metric.

At step 330, the first customer record may be determined to correspond to the same customer as the second customer record. This may be based on some or all of the contact information present in the first customer record and the second customer record, such as an address, name, email address, phone number, Social Security number, date of birth, organization name (e.g., company name), credit card/debit card/stored value card number, account identifier, loyalty program identifier, etc. A threshold comparison may be used: for example, if at least two or three pieces of contact information are a match between the first customer record and the second customer record, the customer records may be considered to be associated with the same customer. In some embodiments, a probability-based statistical analysis may be used to determine which data sources or attributes are most effective.

At step 340, a customer lifetime value (CLV) metric may be calculated for the customer using information from both the first customer record and the second customer record. Since these two customer records are associated with different clients, neither client on its own would be able to create a CLV metric using data from both customer records. The CLV metric may use information present in one of the customer records and/or information present in both of customer records, such as: a purchase/sales history (e.g., information on quantities, dates, and types of goods and/or services bought or sold to or from the client), a customer service history (e.g., the dates, times, and lengths, of interactions with the client's customer service providers), and/or a return history (e.g., indications of products and/or costs of products that have been returned, either for a refund, exchange, or via a warranty).

At step 350, the CLV metric may be provided, or made available to one or more clients, such as the first client and the second client. For instance, for both the first and second client agreeing to allow their customer records to be used for calculating the CLV metric, each of these clients may receive access to the same calculated CLV metric. At step 350, the CLV metric may be sent to each client or may be made available to each client. The CLV metric may be a single number which may allow for easy interpretation, such as a value between 0 and 100. While method 300 involves only two clients, it should be understood that method 300 may involve using customer records from some or all of the client data hosted by the cloud-based service provider operating the cloud host computer system.

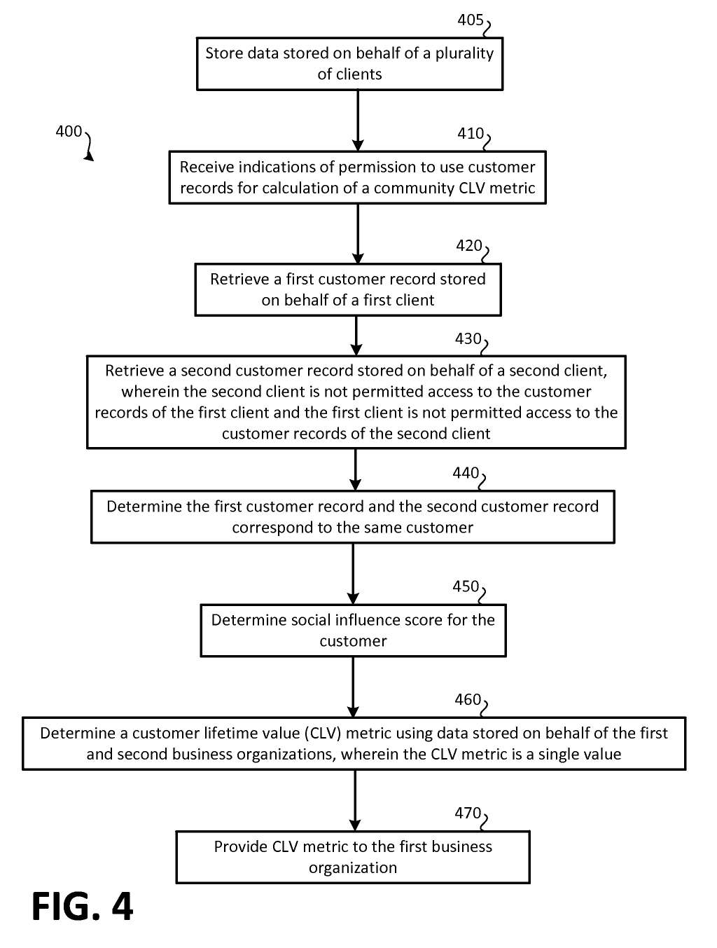

FIG. 4 illustrates another embodiment of a method 400 for determining a customer lifetime value metric. Method 400 may be performed by a computer system including one or more computers. For example, method 400 may be performed by cloud host computer system 130 of FIG. 1. Similarly, method 400 may be performed using system 200 of FIG. 2, which may represent components of cloud host computer system 130. Accordingly, means for performing method 400 includes one or more computers (including servers), computer-readable storage devices, one or more networks, and one or more client computer systems. Method 400 may represent a more detailed embodiment of method 300 of FIG. 3.

At step 405 multiple clients may use the cloud host computer system of a cloud-based service provider to process and/or store data. Such data may include records with information about customers. Referring to FIG. 1, clients may use client computer systems 110 to provide data to cloud host computer system 130 via networks 120 for storage and/or processing. The data provided by each client may be maintained private for that client. As such, a client may not have access to any other clients' data stored by cloud host computer system 130.

At step 410, an indication of a permission to use customer records for calculation of a community CLV metric may be received by the cloud-based service provider from at least some clients of the plurality of clients. Clients that do not provide permission may not have their customer records used by the cloud-based service provider in calculating the community CLV metric. Such clients may also not receive access to the calculated CLV metric. As such, only clients that permit access to their customer records by the cloud-based service provider for use in calculating the CLV metric are provided with the CLV metric.

At step 420, a first customer record may be retrieved from storage. The first customer record may be stored by the cloud-based service provider using a cloud host computer system. The customer record may include: contact information (e.g., a business phone number, a cellular phone number, an address, a mailing address, an email address, a webpage of the customer, etc.), a purchase/sales history (e.g., information on quantities, dates, and types of goods and/or services bought or sold to or from the client), a customer service history (e.g., the dates, times, and lengths, of interactions with the client's customer service providers), and/or a return history (e.g., indications of products and/or costs of products that have been returned, either for a refund, exchange, or via a warranty). It should be understood that such information about a customer is provided as an example; different clients may store different types of information about their respective customers.

At step 430, a second customer record may be retrieved from storage. The second customer record may be stored by the cloud-based service provider using the same cloud host computer system. The second customer record may contain at least some information similar to the first customer record, such as similar contact information. While the cloud-based service provider may store the first and second customer record, these records may be maintained separately such that the first client does not have access to the second client's customer records. Likewise, the second client may not have access to the first client's customer records. More generally, the first client may only have access to data provided to the cloud host computer system by the first client and the second client may only have access to data provided to the cloud host computer system by the second client.

The second customer record may be in a different format than the first customer record. As such, the system performing method 400 may be able to parse information stored in different formats for different clients. For instance, the first customer record may contain contact and purchase information about the customer, while the second customer record may only contain contact information, with sales data stored in a database that must be accessed separately. The system performing method 400 may be configured to handle such variable data storage arrangements.

At step 440, the first customer record may be determined to correspond to the same customer as the second customer record. This may be based on some or all of the contact information present in the first customer record and the second customer record, such as address, name, email address, phone number, social security number, date of birth, organization name (e.g., company name), credit card/debit card/stored value card number, account identifier, loyalty program identifier, etc. A threshold comparison may be used: for example, if at least two or three pieces of contact information are a match between the first customer record and the second customer record, the customer records may be considered to be associated with the same customer.

It should be understood that additional customer records stored on behalf of additional clients may be retrieved by the cloud host computer system and may be found to correspond to the same customer. For example, the same customer may have customer records with many clients who store and/or process data with the cloud-based service provider. While retrieval of only two customer records that are associated with the same customer are present in method 400, more customer records may be determined to be associated with the same customer. Conversely, a customer may be determined to be associated with only one customer record stored by the cloud host computer system. The CLV metric may be calculated based on only the one customer record.

At step 450, social influence data, such as from social networks, may be gathered and may be used to calculate a social influence score. The social influence score, or the social influence data directly, may be used in calculating the CLV metric for a customer. The greater the social influence of a customer, the greater the CLV metric may be to reflect the customer's social influence. A low social influence may result in a CLV metric being lowered to reflect how the customer may be unlikely to negatively affect the perception of clients with other current or potential customers. The social influence score may be calculated by the cloud host computer system or may be retrieved from a third-party.

At step 460, a community customer lifetime value (CLV) metric may be calculated for the customer using information from both the first customer record, the second customer record, and the social influence score/data. Since these two customer records are associated with different clients, neither client, on its own, would be able to create a community CLV metric using data from both customer records. The community CLV metric may use information present in one of the customer records and/or information present in both of customer records, such as: a purchase/sales history (e.g., information on quantities, dates, and types of goods and/or services bought or sold to or from the client), a customer service history (e.g., the dates, times, and lengths, of interactions with the client's customer service providers), and/or a return history (e.g., indications of products and/or costs of products that have been returned, either for a refund, exchange, or via a warranty). The CLV metric may be a single number which may allow for easy interpretation, such as a value between 0 and 100.

At step 470, the CLV metric may be provided, or made available to one or more clients, such as the first client and the second client. For instance, for both the first and second client providing an indication at step 410 to allow their customer records to be used for calculating the community CLV metric, each of these clients may receive access to the community CLV metric. At step 470, the community CLV metric may be sent to each client or may be made available to each client. The CLV metric may only be made available to: clients that have a customer record that corresponds to the customer and/or clients that have given permission of their customer records to be used in calculating the CLV metric.

The CLV metric provided by the cloud-based service provider may be referred to as a community CLV metric because it is based on client-specific information from multiple clients. While a client's information stored by the cloud-based service provider is typically proprietary to the particular client, this proprietary information may be used to determine a community CLV metric that is shared with multiple clients. As such, while clients may not be permitted to access each other client's customer records, the clients may be permitted to access a CLV metric that was calculated using other client's customer records. The CLV metric may be a single number. By the CLV metric being a single number, the risk of proprietary information of a particular customer being inadvertently divulged to other clients is limited. For instance, for all clients that can access a CLV metric for a particular customer, the CLV metric may be a “black box.” That is, clients may not know: who the other clients are whose customer records were used in computing the CLV metric, what information other client's customer records for the customer contain, and/or how many clients have customer records for the customer.

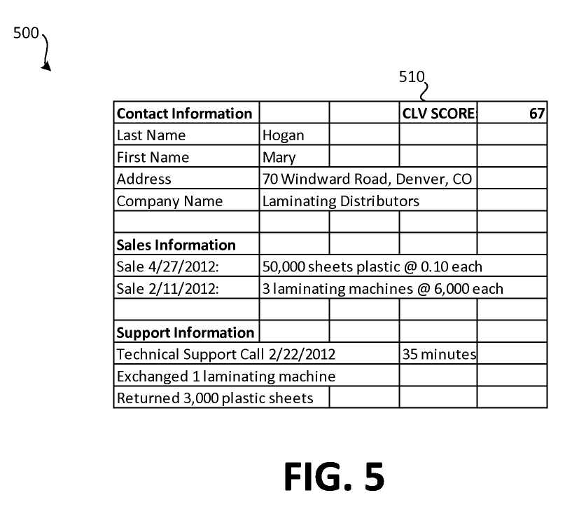

FIG. 5 illustrates an embodiment of a customer record 500 which may be used for determining a customer lifetime value metric. In customer record 500, contact information is present for a customer, including the customer's first and last name, address, and company name. Included in customer record 500 is sales information and support information. Both of these types of information may be used in calculating a customer's CLV. The specific information in customer record 500 stored by the cloud host computer system may remain proprietary to the client that provided the data for customer record 500; however a CLV metric may be calculated using the information present in customer record 500. This CLV metric may be provided to one or more other clients.

CLV metric 510 may be a single number, possibly from 1 to 100. In this embodiment, the cloud host computer system edits the customer record to indicate the CLV metric. In other embodiments, CLV metric 510 may be made available for retrieval from cloud host computer system by the client associated with the customer record. Customer record 500 is a simplified example only; other embodiments of a customer record may contain similar information, but may be arranged differently. Further, rather than a single customer record containing contact, sales, and/or support information being present, such data may be spread among multiple records stored by the host computer system on behalf of the client.

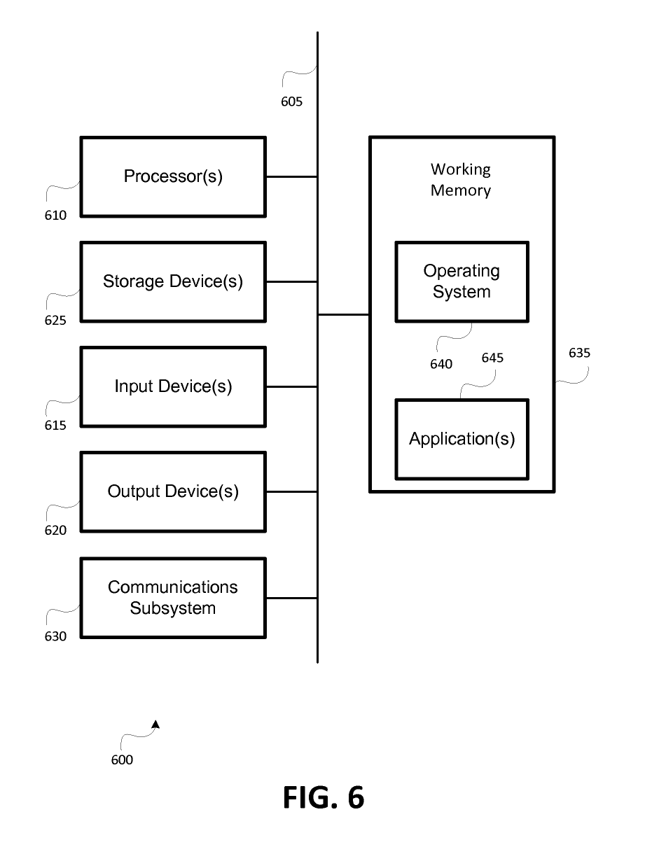

FIG. 6 illustrates an embodiment of a computer system 600. A computer system as illustrated in FIG. 6 may incorporate as part of the previously described computerized systems. For example, computer system 600 can represent some of the components of the client computer system and/or cloud host computer systems discussed in this application. FIG. 6 provides a schematic illustration of one embodiment of a computer system 600 that can perform the methods provided by various embodiments, as described herein. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a mouse, a keyboard, and/or the like; and one or more output devices 620, which can include without limitation a display device, a printer, and/or the like.

The computer system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device, and/or a chipset (such as a Bluetooth™ device, an 802.11 device, a WiFi device, a WiMax device, cellular communication facilities, etc.), and/or the like. The communications subsystem 630 may permit data to be exchanged with a network (such as the network described below, to name one example), other computer systems, and/or any other devices described herein. In many embodiments, the computer system 600 will further comprise a working memory 635, which can include a RAM or ROM device, as described above.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 625 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. Further, for cloud-based hosting environments, a distributed arrangement may be used where individual nodes of a system process different portions of a larger data set. It should be understood that processes and methods performed by a computer system detailed herein may be performed via a distributed computing platform using many computer systems.

As mentioned above, in one aspect, some embodiments may employ a computer system (such as the computer system 600) to perform methods in accordance with various embodiments of the invention. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the non-transitory storage device(s) 625. Merely by way of example, execution of the sequences of instructions contained in the working memory 635 might cause the processor(s) 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 625. Volatile media include, without limitation, dynamic memory, such as the working memory 635.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 630 (and/or components thereof) generally will receive signals, and the bus 605 then might carry the signals (and/or the data, instructions, etc. carried by the signals) to the working memory 635, from which the processor(s) 610 retrieves and executes the instructions. The instructions received by the working memory 635 may optionally be stored on a non-transitory storage device 625 either before or after execution by the processor(s) 610.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bind the scope of the claims.

What is claimed is:

1. A method for determining a customer's value, the method, comprising:
accessing, by a cloud host computer system, a first customer record stored by the cloud host computer system on behalf of a first client, wherein:
the first customer record comprises information about a first financial relationship between a customer and the first client;
accessing, by the cloud host computer system, a second customer record stored by the cloud host computer system on behalf of a second client, wherein:
the second customer record comprises information about a second financial relationship between the customer and the second client;
the first client does not have access to the second customer record; and
the second client does not have access to the first customer record;
determining, by the cloud host computer system, the customer of the first customer record and the customer of the second customer record are the same;
determining, by the cloud host computer system, a community customer lifetime value metric using information about the first financial relationship and information about the second financial relationship; and
providing, by the cloud host computer system, the community customer lifetime value metric to the first client.

2. The method for determining the customer's value of claim 1, wherein the customer lifetime value metric is the only metric provided to the first client by the cloud host computer system based on the second customer record.

3. The method for determining the customer's value of claim 1, wherein:
the information about the first financial relationship between the customer and the first client comprises information about revenue received by the first client from the customer; and
the information about the second financial relationship between the customer and the second client comprises information about revenue received by the second client from the customer.

4. The method for determining the customer's value of claim 1, wherein:
the information about the first financial relationship between the customer and the first client comprises information about customer-support costs of the customer with the first client; and
the information about the second financial relationship between the customer and the second client comprises information about customer-support costs of the customer with the second client.

5. The method for determining the customer's value of claim 1, wherein the customer is a person.

6. The method for determining the customer's value of claim 1, wherein the customer is a business organization.

7. The method for determining the customer's value of claim 1, further comprising:
accessing, by the cloud host computer system, a social influence score for the customer, wherein:
the social influence score indicates a likelihood of the customer being able to influence behavior of people; and
determining, by the cloud host computer system, the community customer lifetime value metric using the first financial relationship and the second financial relationship further comprises using the social influence score for the customer.

8. The method for determining the customer's value of claim 1, further comprising:
accessing, by the cloud host computer system, a plurality of customer records stored by the cloud host computer system on behalf of a plurality of clients, wherein:
the plurality of customer records corresponds to the customer;
the plurality of customer records comprise information about a plurality of financial relationships between the customer and the plurality of clients; and
determining, by the cloud host computer system, the community customer lifetime value metric using the first financial relationship and the second financial relationship further comprises using the information about the plurality of financial relationships between the customer and the plurality of clients.

9. The method for determining the customer's value of claim 8, wherein providing, by the cloud host computer system, the community customer lifetime value metric to the first client further comprises providing the community customer lifetime value metric to each client of the plurality of clients.

10. The method for determining the customer's value of claim 1, further comprising:
receiving, by the cloud host computer system, an indication that the first client is enrolled in a community customer lifetime value program, wherein:
the community customer lifetime value program permits access community to customer lifetime value metrics for a plurality of customers determined using at least some data not available to the first client; and
the community customer lifetime value program requires customer records, that are stored on behalf of the first client by the cloud host computer system, be available for use in determining the community customer lifetime value metrics for the plurality of customers.

11. A computer program product residing on a non-transitory processor-readable medium for determining a customer's value, the computer program product comprising processor-readable instructions configured to cause a processor to:
access a first customer record stored by a cloud host computer system on behalf of a first client, wherein:
the first customer record comprises information about a first financial relationship between a customer and the first client;
access a second customer record stored by the cloud host computer system on behalf of a second client, wherein:
the second customer record comprises information about a second financial relationship between the customer and the second client;
the first client does not have access to the second customer record; and
the second client does not have access to the first customer record;
determine the customer of the first customer record and the customer of the second customer record are the same;
determine a community customer lifetime value metric using information about the first financial relationship and information about the second financial relationship; and
provide the community customer lifetime value metric to the first client.

12. The computer program product for determining the customer's value of claim 11, wherein the customer lifetime value metric is the only metric provided to the first client based on the second customer record.

13. The computer program product for determining the customer's value of claim 11, wherein:
the information about the first financial relationship between the customer and the first client comprises information about revenue received by the first client from the customer; and
the information about the second financial relationship between the customer and the second client comprises information about revenue received by the second client from the customer.

14. The computer program product for determining the customer's value of claim 11, wherein:
the information about the first financial relationship between the customer and the first client comprises information about customer-support costs of the customer with the first client; and
the information about the second financial relationship between the customer and the second client comprises information about customer-support costs of the customer with the second client.

15. The computer program product for determining the customer's value of claim 11, wherein the customer is a person.

16. The computer program product for determining the customer's value of claim 11, wherein the customer is a business organization.

17. The computer program product for determining the customer's value of claim 11, further comprising processor-readable instructions configured to cause the processor to:
access a social influence score for the customer, wherein:
the social influence score indicates a likelihood of the customer being able to influence behavior of people; and
determine the community customer lifetime value metric using the first financial relationship and the second financial relationship further comprises using the social influence score for the customer.

18. The computer program product for determining the customer's value of claim 11, further comprising processor-readable instructions configured to cause the processor to:
receive an indication that the first client is enrolled in a community customer lifetime value program, wherein:
the community customer lifetime value program permits access community to customer lifetime value metrics for a plurality of customers determined using at least some data not available to the first client; and
the community customer lifetime value program requires customer records, that are stored on behalf of the first client by the cloud host computer system, be available for use in determining the community customer lifetime value metrics for the plurality of customers.

19. A system for determining a customer's value, the system comprising:
a processor; and
a memory communicatively coupled with and readable by the processor and having stored therein processor-readable instructions which, when executed by the processor, cause the processor to:
access a first customer record stored on behalf of a first client, wherein:
the first customer record comprises information about a first financial relationship between a customer and the first client;
access a second customer record stored on behalf of a second client, wherein:
the second customer record comprises information about a second financial relationship between the customer and the second client;
the first client does not have access to the second customer record; and
the second client does not have access to the first customer record;
determine the customer of the first customer record and the customer of the second customer record are the same;
determine a community customer lifetime value metric using information about the first financial relationship and information about the second financial relationship; and
provide the community customer lifetime value metric to the first client.

20. The system for determining the customer's value of claim 19, wherein the customer lifetime value metric is the only metric provided to the first client based on the second customer record.
